(19) United States
(12) Patent Application Publication
(10) Pub. No.: US 2003/0023975 A1
(43) Pub. Date: Jan. 30, 2003

(54) Enhanced music services for television

(75) Inventors: Joseph A. Schrader, Los Altos, CA (US); Jeffrey D. Crawford, San Francisco, CA (US); Alvin P. Lee, Oakland, CA (US); Andrew M. Simms, Fountain Hills, AZ (US); Samuel T. Scott, Los Gatos, CA (US); William M. Crow, Sequim, WA (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: Microsoft Corporation, Redmond, WA (US)

(21) Appl. No.: 10/186,107

(22) Filed: Jun. 28, 2002

Related U.S. Application Data
(63) Continuation-in-part of application No. 09/903,973, filed on Jul. 12, 2001.
(60) Provisional application No. 60/273,139, filed on Mar. 2, 2001.

(51) Int. Cl. G06F 3/00; H04N 5/445; G06F 13/00

(52) U.S. Cl. 725/51

(57) ABSTRACT

An enhanced television navigation service supplies broadcast television music programming, digital audio and related content. The related content is linked with the broadcast programming and is presented to the user. By linking the related content with the programming in this fashion, the user can tune to a program based on information indicators presented by the service.

### CROSS REFERENCE TO RELATED APPLICATIONS

This application is a continuation-in-part of application Ser. No. 09/903,973, filed Jul. 12, 2001, entitled “Enhanced Television Service.” The subject matter of that application is incorporated herein by reference in its entirety.

### FIELD OF THE INVENTION

The present invention generally relates to manipulating data in entertainment systems and services, and more particularly, the invention relates to a music service and system for providing that service.

### BACKGROUND OF THE INVENTION

Television and audio programming has conventionally been accessed through communication channels such as airwave broadcast, cable providers, and satellite transmission. Programming services provide users a wide variety of entertainment, sports, news, advertisements and educational programming. They typically offer numerous programs at any given time.

To enable navigation through a listing of available programs, many known services also supply an Electronic Programming Guide (“EPG”) to the user. The EPG is presented to the user as a static listing of available programming. The data included in the EPG is periodically updated and then downloaded to the user, and thus enables a user to search for a particular program of interest. However, with the large amount of programming available, it is often difficult for the user to make an informed decision concerning the most desirable programming at any particular time, even with the use of the EPG. That is because known filtering mechanisms, even if used to present EPG data, often provide an unsatisfactory user experience due to the volume of information that is presented. Additionally, the data itself is often stale by the time the programming is broadcast. This is particularly true for video and audio music services. Also, based on the manner in which such content is now distributed and licensed, broadcast stations cannot preannounce play lists. Thus, the information provided by the EPG does not contain the granularity to accurately reflect what is currently being broadcast, particularly as it relates to music offerings.

Internet-based scheduling services for informing users of televised music programs are also known. For example, Web sites such as http://www.musicstation.com/rockontv/ provide scheduling information of upcoming music-based television programs for a given time period. This service, however, is not tailored to the specific interests of any particular user. Moreover, it does not permit the user to obtain, substantially in real-time, currently available music programming across numerous channels.

It would therefore be desirable to permit users to exert a greater degree of control over broadcast video and audio. It would also be desirable to provide a system and service in which data, such as real-time data, may be associated with broadcast audio and video programming in order to deliver an enhanced experience.

### SUMMARY OF THE INVENTION

The present invention provides an enhanced television viewing and listening experience in a system and method that utilizes real time and/or other data that is linked together with broadcast audio and video programming. According to one aspect of the invention, the broadcast programming is combined with related content such as Internet protocol (“IP”) content to assist user navigation across multiple audio and video music items. In this aspect, a navigation tool associates a particular music program with the related content based on a unique identifier. Based on the related content, the invention creates a real-time play-list of currently available music programming. When a user selects an item in the play-list, such as by selecting one of a plurality of visual cues, the system tunes to the channel corresponding to the selected program. The play-list is updated as new music items are broadcast.

### BRIEF DESCRIPTION OF THE DRAWINGS

FIG. 1 is a block diagram representation of a client-server system in one operative environment of the present invention;

FIG. 2 is a block diagram representation of another illustrative operative environment for the present invention;

FIG. 3 is a data structure corresponding to the general data types that are transmitted from a server to one or more client systems according to the invention;

FIG. 4 is a block diagram representation of certain components that are used in the client-server system shown in FIG. 1;

FIG. 5 is a block diagram representation of an illustrative client system that may be used according to the invention;

FIG. 6 is a flow chart illustrating certain operational aspects of a music content aggregator component as shown in FIG. 4;

FIG. 7a is a flow chart illustrating certain operational aspects of an application executing on the client system shown in FIG. 5 according to one embodiment of the invention;

FIG. 7b is a flow chart illustrating certain operational aspects of an application executing on the client system shown in FIG. 5 according to another embodiment of the invention;

FIG. 8 illustrates a music navigation guide according to the invention;

FIG. 9 illustrates a navigation guide similar to the guide in FIG. 8 having a selectable music play-list according to the invention;

FIG. 10 shows the navigation guide of FIG. 9 after selection of a navigation element presented in the music play-list;

FIG. 11 is another view of the navigation guide of FIG. 10 that has been updated based on user selection of a navigation element presented in the screen shown in FIG. 10;

FIG. 12 is yet another view of the navigation guide in FIGS. 10 and 11 that has been updated as a result of a new song being broadcast on the user selected channel; and

FIG. 13 illustrates a music navigation guide that is similar to that shown in

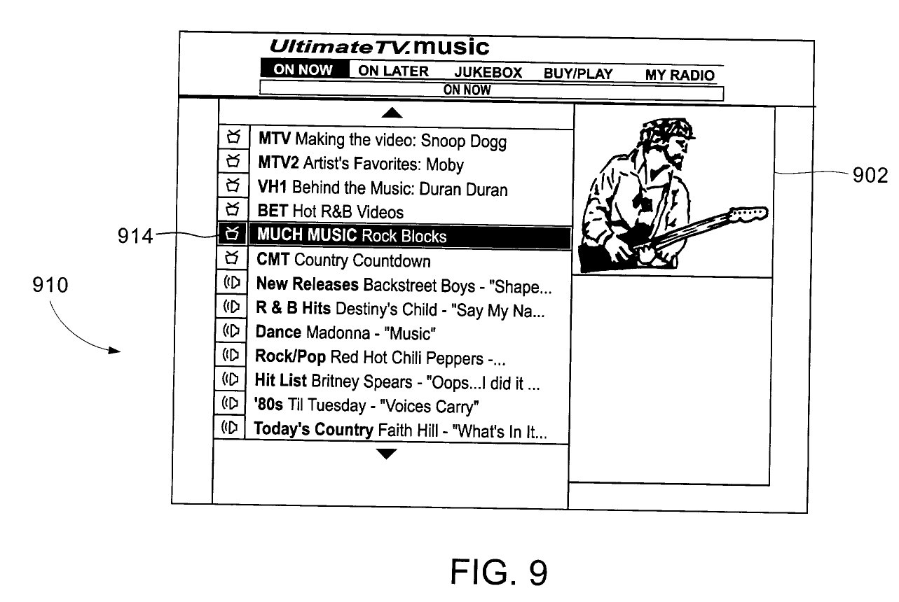

FIGS. 9-12 but is directed to music items that will be shown at a future time.

### DETAILED DESCRIPTION OF THE INVENTION

This invention relates to systems and methods for delivering music programming and related content. More specifically, the invention provides a navigation service that associates broadcast music programming with related content, sometimes encoded as Internet protocol (“IP”) data. The related content usually includes real-time music play-list data, among other things. A user may readily make an informed choice of currently available music selections by selecting desired programming on an interface screen. In one embodiment, the invention segregates a video display into various display areas including a navigation display portion and a program display portion. The navigation display portion helps users easily browse and select from a play-list of currently broadcast audio and music video programming. Selecting a navigation element within the navigation display portion causes the system to tune to the program corresponding to the selected navigation element. By linking or associating parallel sources of data in this fashion, the user can tune to one or a multiplicity of music-related programs based on an informed choice presented on the display.

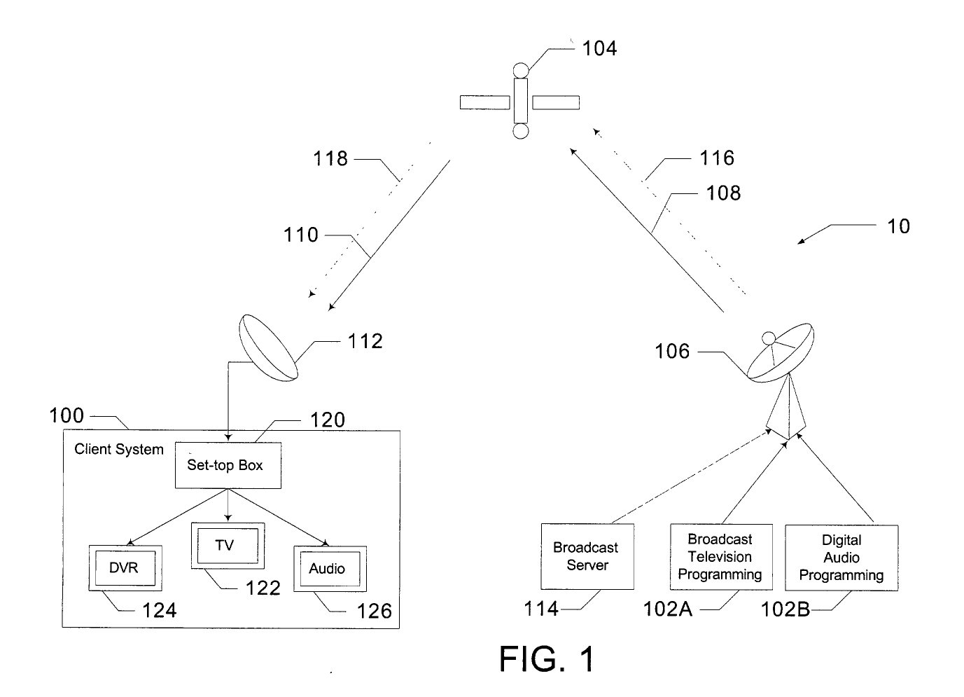

FIG. 1 illustrates a block diagram representation of a suitable environment for a navigation system 10 according to the present invention. In this embodiment, a client-server system provides broadcast music television and audio programming, as well as Internet protocol (IP) data over data broadcast channels. As used herein, IP data or “related content” refers to data that is packaged in accordance with a protocol that informs the transmission network how data packets are addressed and routed. Those skilled in the art will appreciate that, while the invention is described primarily in the context of providing IP data in parallel with a broadcast channel, other types of data may be transmitted as well. That is, the invention may be incorporated in any environment in which data streams are intended to be associated with television and/or audio programming in some way.

As shown in FIG. 1, television programming, as denoted by the functional block 102a, is broadcast to one or more client systems via a broadcast network denoted by a digital satellite system 104. In particular, the available television programming is up-linked via a transmitter 106 to the satellite system 104 over a communication channel 108. In this point-to-multipoint system, the programming is down linked via a data communication channel 110 to a plurality of client systems, one of which is shown as client system 100. The client system includes receiver 112, as shown diagrammatically in FIG. 1, to capture the programming.

Digital audio broadcast programming and services, denoted by a block 102b in FIG. 1, are also provided over the broadcast network. As with the television programming, these services are provided by the digital satellite system 104 in the embodiment shown in FIG. 1. In one embodiment, more than thirty audio-only channels may be provided by the service. The digital audio content is typically compressed and transmitted over fairly low bandwidth data channels allocated by the broadcast satellite system. In this example, the digital audio channels are dedicated to music of a particular genre, such as classical, easy listening, classic rock or alternative rock.

In addition to the broadcast television programming and digital audio services, a parallel data stream, such as a content stream related to the video and audio programming, is generated by a Broadcast Server 114. The parallel data stream is similarly up-linked to the satellite system 104 via a data communication channel 116. The related content stream is down linked to the client system 100 via a second downlink communication channel 118. As explained below, a receiver 120 or other similar computing device decodes and processes the data received from the antenna receiver 112. The client system 100 also includes a display device such as television (TV) 122. Alternate embodiments include Personal Digital Assistants (PDAs), cellular telephones and other computing devices, and optionally other audio/visual equipment. In FIG. 1, such equipment includes an external digital video recorder (DVR) 124 and an Audio system 126.

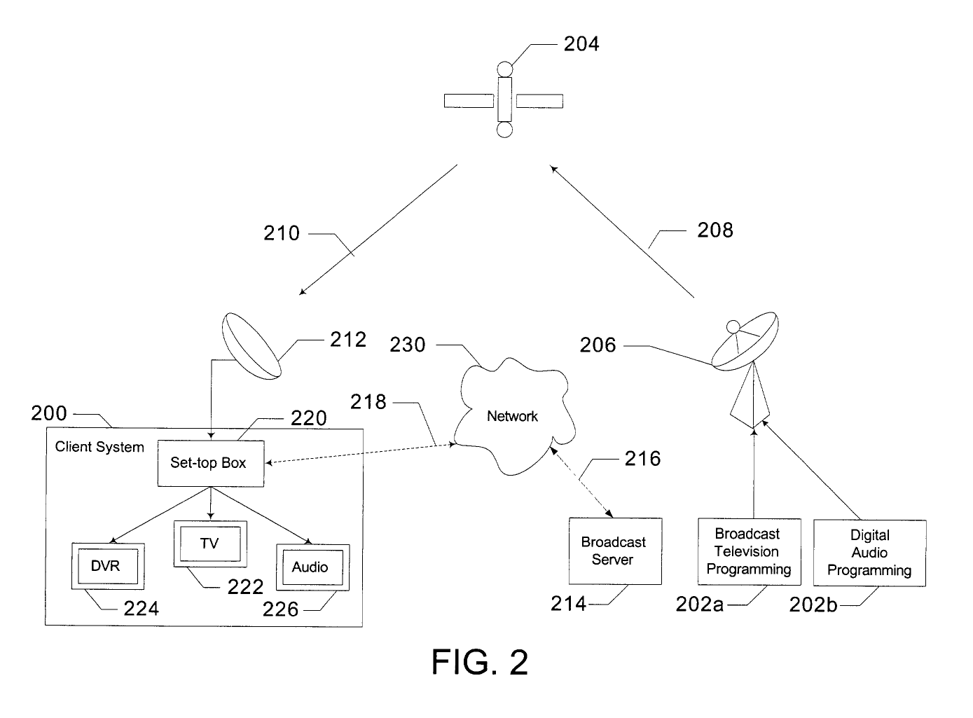

Data services are sometimes transmitted to the client system via a network 230, as illustrated in FIG. 2. This embodiment is similar to the embodiment in FIG. 1 in that broadcast television and audio programming data (provided by the blocks 202a and 202b) is up-linked to a satellite system 204 via transmitter 206 over a communication channel 208. The programming data is down linked to the client system 200 via a communication channel 210 to antenna receiver 212. However, in FIG. 2, related content is transmitted to the client system 200 via the Wide Area Network (WAN) network 230 through network connections 216 and 218. The client system 200 in this embodiment also accesses the Broadcast Server 214 via the WAN. The client system 200 also includes a digital video recorder 224, a television device 222 for displaying video program content and an audio device 226 for rendering audio program content.

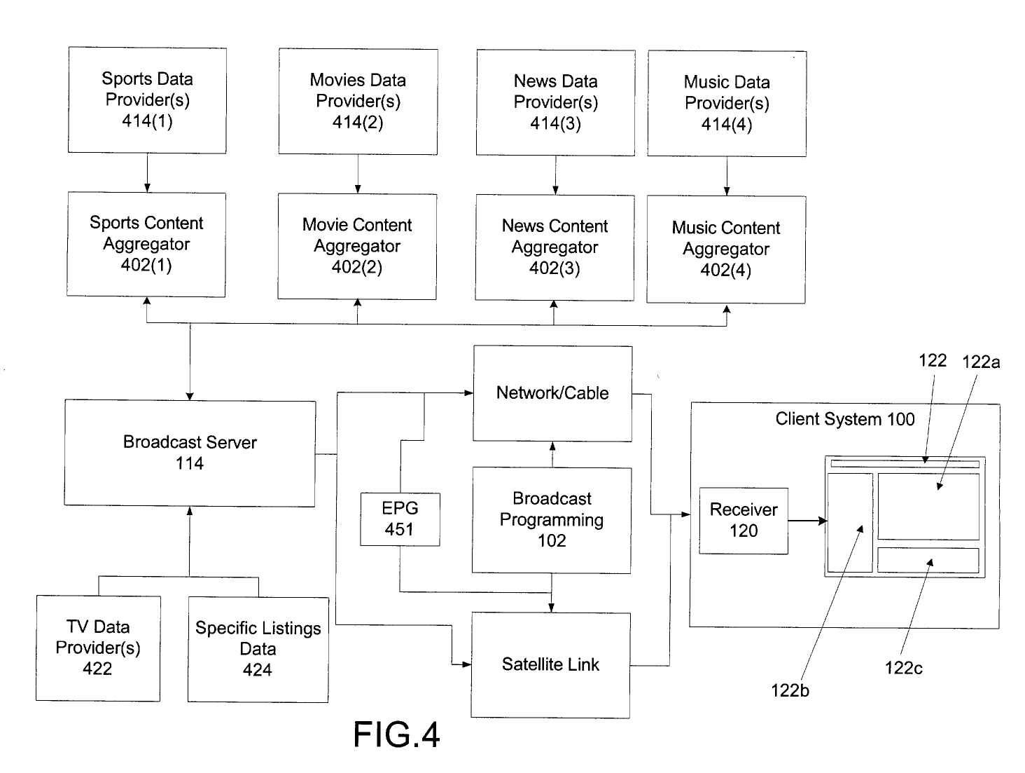

While FIG. 1 and FIG. 2 illustrate delivery of digital audio services and video programming via a satellite system, such programming may alternatively be delivered via a cable television system. In one embodiment of the invention, television and audio programming is provided through a digital cable system that delivers multiple channels of video data in a compressed format, such as MPEG II format. In this embodiment, the cable provider typically allocates dedicated channels for transmission of compressed digital audio content. Other broadcast systems may be used to deliver the services to various users. Thus, FIG. 4 shows delivery of broadcast programming through either (or both) a satellite link or through a network/cable system. Similarly, the broadcast television programming may be provided through a first type of system and the digital audio services through another system. In some cases, the digital audio may even be provided via the WAN.

For both the satellite and digital cable embodiments, data services in the form of enhanced content may be provided to the client systems in a dedicated data communication channel. In this embodiment, the Broadcast Server 114 or head-end pre-allocates the bandwidth to accommodate the data services in a channel or bundle of channels that are reserved for exclusive use of these services. However, data services may be transmitted in any manner. For example, such data services may be replicated over some or all of the content channels as a “trickle feed.” Therefore, the client receives the data stream regardless of the content channel tuned by the viewer. Since it is replicated for some or all of the content channels, it is a small bandwidth channel due to practical limitations. The use of a trickle stream avoids the allocation of additional communication channels.

To reduce the bandwidth, the generated trickle stream preferably contains only dynamic content such as real-time play list update notifications and other programming updates. Other content may be periodically transmitted either via a separate broadcast data communication channel or via the WAN. This embodiment may be used where bandwidth at the server or head-end is not pre-allocated. The use of a trickle stream further provides advantages on the client side since a tuner need not be tuned to the channel delivering the related content to obtain the enhanced services. This feature enables the services according to the present invention to be delivered to low-end client systems, such as client systems having a single tuner. In addition, the use of a trickle stream provides greater user option and control over the television viewing experience.

Other transports may be used to deliver the enhanced data stream. By way of example, a non-program synchronous ATVEF transport may be used in some instances.

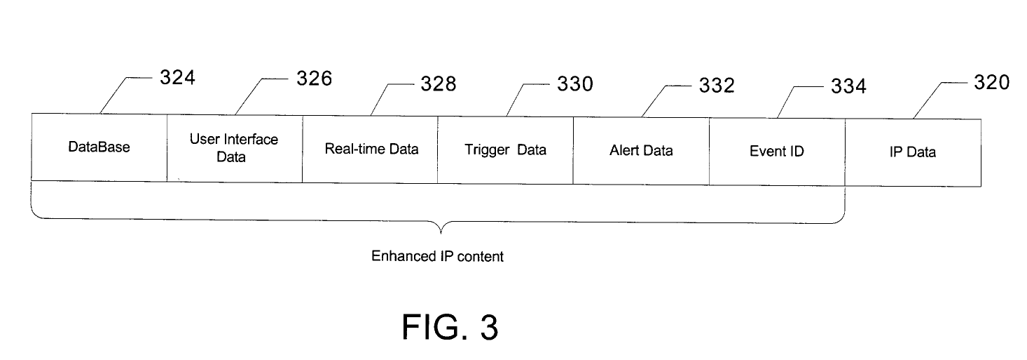

FIG. 3 illustrates an exemplary data structure for such data services. An IP data header 320 specifies network protocol information, information concerning transfer between applications, and an appropriate encoding method, for example, NTSC compliant encoding. The IP data 320 encapsulates information concerning one or more audio or video music programs. Such data generally includes database information 324 and/or user interface information 326 for creating an enhanced navigation tool to permit the user to perform an informed search for a particular program. This information may be packaged as HTML files or other types of data files.

As explained below, the enhanced data is sometimes augmented with, among other things, real-time data 328, trigger data 330 and Alert data 332. “Enhanced IP data” or “Enhanced Data” refer to any type of data that includes associated identification data or can be associated with a particular television program in some fashion. In any circumstance, such data is coupled with identification data, shown in FIG. 3 as an Event Identifier 334, associating the data packet with a corresponding television or audio program. The Event ID is an ID that associates any type of enhanced data to a television or audio program. The Event ID may be created by using a custom ID that is assigned to enhanced data, the Event ID may be created by mapping heterogeneous IDs previously assigned to enhanced data or broadcast programming into a single homogeneous Event ID system, or the Event ID may be derived from or be the same as a pre-existing universal ID system, if one is available.

Thus, in accordance with the present invention, an Event Identifier is provided for each television program and for the audio content that is available through the service. Other information may also be included such as an event time and a market identifier corresponding to the channel number or tuner position for a particular local market. In this embodiment, then, an enhanced listing is created at the client systems subscribing to the service. The entries in the listing sometimes include an Event Identifier, the title of the video or audio channel and the currently playing song or program, if any.

Thus, the enhanced data is typically augmented in some fashion before it is routed to the client system. For example, real-time event data relating to the active status of available television programming may be inserted in the enhanced data stream and provided to the client system. Also, data relating to a currently playing song is provided to the client system. Such data is used to create various real-time tunable alerts, triggers or filters and the like. The client system processes such data to create real-time visual indicators and cues and presents the visual indicators and cues together with enhanced data. Thus, for example, data corresponding to currently broadcast music programming and for invoking specific actions are provided to the client system. As explained below, the real-time data may be transmitted as event-based Extensible Markup Language (XML) representations.

In one embodiment, such enhanced data is routed to the client systems through the transmission of IP encapsulated data from a server. The server is a dedicated server in one embodiment. Alternatively, the server may be located at the head-end of various cable operators, for example, the server 114 illustrated in FIG. 1 and FIG. 4 or the server 214 in FIG. 2. The XML event data is sometimes supplied to the client systems independent of the enhanced schedule data, but may be used in conjunction with such data in other embodiments.

The communication channel 218 shown in FIG. 2 may also be used as a back-channel to enable the initiation of requests for Internet services by the client system 200. In this way, additional data concerning the programming currently being broadcast may be retrieved from the Internet and provided to the user as well. For example, the data may permit the user to connect to a related web site to obtain relevant information concerning the broadcast.

The embodiment described below relates to the delivery of information related to music audio and video programming. In this case, a data provider and/or broadcast server create the real-time and other content that is delivered to the client system. A music content aggregator creates a normalized data stream that includes an Event Identifier associated with each music related event or meta data provided by external music service providers.

The content aggregator transmits the normalized data stream with prioritization to a broadcast server. The normalized data stream preferably conforms the various data received by the music content aggregator to an API being used by the broadcast server. The broadcast server then matches a local line-up data to the Event IDs being transmitted by the content aggregator to create a new themed programming schedule indexed by Event ID, in this example, the theme being music. The content aggregator receives data from external sources that has no data ID or its own unique data ID. The content aggregator maps the data to a single Event ID system, and transmits the normalized data to the broadcast server as indexed by Event ID.

Alternatively, the content aggregator receives the external data already mapped to a single Event ID system. The broadcast server then periodically supplies the updated enhanced schedule to the client systems. When a music event is broadcast, the content aggregator aggregates and normalizes one or more data feeds to generate certain play-list updates, real-time event notifications, alert notifications and other data that are mapped to an Event Identifier. This enables a client system to manipulate such data to present, among other things, tunable alerts and other real-time indicators that have previously been associated with an appropriate Event Identifier. In response to selecting such a tunable alert, the client system tunes the television to the channel corresponding to the Event Identifier. The client system also uses such data to indicate other information, such as status information indicating that a particular program or song is playing, duration of time remaining for the song, or other information related to the particular song that is currently playing that may be of interest to the listener.

As shown in FIG. 4, a Broadcast Server 114 operates in conjunction with several components to create the data services associated with the video and audio program content stream delivered to the client systems. Various content aggregators 402 generate normalized data feeds corresponding to various events or pieces of content that may be available for viewing or listening. For example, the Music Content Aggregator 402(4) receives various digital audio and video feeds based on songs or programs that are currently playing on various audio and television channels.

The various Data Providers capture various events and other data related to the broadcast programming. In FIG. 4, the Data Providers include a Sports Data Provider 414(1), a Movies Data Provider 414(2), a News Data Provider 414(3), and a Music Data Provider 414(4). The data feeds provided to the Music Content Aggregator 402(4) include, for example, music status real-time data, discography and editorial data from Internet data services and the like. The Data Providers 414 may be external to the Content Aggregator 402 or portions may be a part of the Content Aggregator 402. As explained below, in one embodiment, the Content Aggregator 402 also receives a plurality of Event Identifiers, each of which corresponds to a particular event or piece of content of interest. Alternatively, the Content Aggregator 402 receives data IDs and the data IDs are then later matched with an Event ID by the Broadcast Server 114, or the Content Aggregator 402 receives data without IDs and transmits the data to the Broadcast Server 114, which then assigns an Event ID to the data.

In one embodiment, the Music Content Aggregator 402(4) then processes the data feeds by assigning priority properties. In particular, information that is considered to be dynamic content, such as the current song or video that is playing on a particular channel, are assigned with “High” priority. A next priority level, such as a “Fast” priority, is assigned to information that does not necessarily need to be supplied to the client systems with the same priority as dynamic content. A “Normal” priority is assigned to information that typically changes on a daily basis, such as news events relevant to a program of interest. Finally, a “Low” priority is assigned to content such as pictures, artist profiles, CD reviews, future tour schedules, or other relatively static information concerning the program of interest.

Assignment of different priority levels to the received data feeds enables the Music Content Aggregator 402(4) to manage the bandwidth of one or more data streams more efficiently and conveniently. In the described embodiment, the Content Aggregator 402 sorts and groups the incoming data feeds according to assigned priority levels. The sorted and grouped data feeds are then output to the Broadcast Server 114, responsive to the assigned priority levels. In one embodiment, multiple data transmission channels are used to transmit the different priority data. For example, a “High” priority data feed transmission; a “Fast” priority data feed transmission, a “Normal” priority data feed transmission; and a “Low” priority data feed transmission may all be used to transmit the data in accordance with the present invention. Thus, the data feeds may be simultaneously transmitted according to their priority levels. In this embodiment, each of the data transmission channels is implemented independent of other channels. Alternatively, a single transmission is generated that accommodates all of the different prioritization levels. The data transmission channels are implemented as either logical channels or physical connection channels. In general, the dynamic content streams associated with real-time events in the music programming are used to generate real-time indicators of current songs of music videos being broadcast. However, such real-time data may also be used to invoke some other action.

In addition to dynamic content concerning the current status of various music events, the Music Content Aggregator 402(4) also generates an index log of certain music events according to predetermined rules. The indices are created from the various data feeds provided by the Music Data providers 414(4), and include data concerning music videos such as the beginning of the video, the video ending, and the like. Then, by way of example, to index a music video, the Content Aggregator 402(4) creates XML representations of music video segments. In this way, the Content Aggregator 402(4) creates real-time DVR data that may be utilized by a client application to permit a “smart skip” or “intelligent skip” forward and backward DVR playback to enable a user to jump between music videos of interest, among other logical skips or jumps in the recorded video.

The event logs are sometimes collected and transmitted to the client systems as a file or a collection of files. Although many formats may be used, in one embodiment the Music Content Aggregator 402(4) creates an index file including XML-based event logs in accordance with a defined schema. The index file also includes various control data. By capturing such index logs, the Music Content Aggregator 402(4) creates a series of XML representations of segments of the music video. These event logs are packaged as a music video index file representing a collection of televised music videos in the above example.

In addition to the program index file, the Music Content Aggregator 402(4) supplies control files to enable the client systems to present a custom user interface during playback. In the above example, the control file is an HTML file. The control file sometimes includes control data providing additional enhancements such as the presentation of an icon indicating to the user that the recording is an “intelligent recording,” or to permit a “skip override” function in which the receipt of a skip input command causes the client system to perform a logical skip between videos, or for other formatting functions such as full screen operation.

The Music Content Aggregator 402(4) optionally performs various post processing with respect to the video index file to provide further enhancements to the index file and/or control file.

Such information is transmitted to a client system where it is associated with the recording obtained by the client system. This permits one or more playback modes such as display of a viewer-selectable list of individual music videos, parental control filters assigned to individual music videos rather than the entire music video program, playback of actual music video only, playback of specific artist, or playback of other highlights according to the created video segments. The information may also be used to enable real-time pause, and intelligent skip backward and forward.

Other information and content, such as pictures, artist profiles, CD reviews, future tour schedules and the like, are assigned with Low priority. According to the invention, High priority information is transmitted dynamically, such as via digital satellite. On the other hand, Low priority information may be transmitted via the same medium but during times when greater volumes of data may be supplied, such as during the night. As explained below, this data usually concerns collateral material such as album cover art, inner artwork, reviews, lyrics, credits, behind-the-scenes material, artist or song profiles, discography and other graphics and/or data. While in the presently preferred embodiment such data, together with an appropriate Event ID, is usually transmitted via satellite-based transmission, it may additionally or alternatively be provided through other transmission channels, for example, via the Internet. The Content Aggregator 402(4) also formats the data streams for optimization as a one-way broadcast to a Broadcast Server 114.

The Event Identifiers may be mapped in various ways to the particular content streams. In the illustrated embodiment, the Music Content Aggregator 402(4) functions to normalize the various data streams to an appropriate Event Identifier. In particular, the Content Aggregator 402(4) retrieves Event Identifiers, each uniquely corresponding to a particular music program as assigned by one or more sources. The Broadcast Server 114 also maintains a database containing line-up entries indexed by Event Identifiers. The Content Aggregator 402(4) also creates new records based on received Event Identification information. In this way, the Content Aggregator 402(4) maps Event Identification data between multiple sources of program information, discography, other broadcast information and enhanced data streams. Alternatively, the Content Aggregator 402(4) maps heterogeneous event ID data into a single homogeneous Event ID system, as discussed previously.

FIG. 4 illustrates additional content aggregators that optionally may be used in accordance with the invention to create Event ID's. As shown, a Sports Content Aggregator 402(1), a Movies Content Aggregator 402(2) and a News Content Aggregator 402(3) also provide normalized output data streams to the Broadcast Server 114. That is, for each television program, movie, or other piece of content, the appropriate service provider creates an Event Identifier for each program, event, or piece of content and associates that Identifier with content related to that program, event, or piece of content. For example, each movie in a movie database may receive an Event ID. Then, meta-data related to the movie is also assigned the same Event ID. Such data may include movie reviews, trailers, previews, interviews, etc.

While the Music Content Aggregator 402(4) operates as a data “push” model in which the various data feeds are aggregated and transmitted to the Broadcast Server, the service providers (including the Music Content Aggregator 402(4)) may optionally function in a “pull” model. For example, the Music Content Aggregator 402(4) may contain a music database, with enhanced content streams, and associated Event Identifiers. In this instance, the Broadcast Server 114, upon receipt of local listings information, polls the Music Content Aggregator 402(4) for enhanced data corresponding to the local listings.

In one embodiment, after receiving the normalized data stream from Content Aggregators 402, the Broadcast Server 114 receives television listing data specifying the local line-up for a given user. Specifically, television data services, such as Tribune Media Service data, are supplied through a data service 422. In addition, data concerning specific program listings provided by local carriers is supplied through a Specific Listings Data Service 424 and are provided to the Broadcast Server 114.

The Broadcast Server then matches the schedule data with the local listing data. In a music embodiment, the Broadcast Server 114 performs the matching by retrieving date, time, and music content names from the data accompanying the Event ID of a particular piece of enhanced data. Then, the Broadcast Server 114 uses conventional fuzzy logic matching to match that with TV listing data which typically comprises date, time, a field indicating whether the event is live, a program description, and a program category. After this matching is performed, the Broadcast Server 114 can create a new enhanced event schedule that correlates enhanced data with the local channel line-up of a particular viewing region. For all of the matching steps, human editing may also be used as a quality check on automated matching. Then, on a periodic basis, the Broadcast Server 114 generates an updated themed (e.g., sports, music, movies, news, etc) schedule in which the Event Identification data is matched with the local television line-up for a specific market, and transmits updated schedule to the client systems.

The modular architecture employed in this embodiment permits the Broadcast Server 114 to route domain specific television schedule data received from the Content Aggregators 402(1), 402(2), 402(3), and 402(4) in the same fashion. Also, the Broadcast Server 114 may customize the schedule data to a specific viewing location. For example, the Broadcast Server is able to match the enhanced data to any changes in local channel lineups since the schedule information is updated daily. This provides advantages over known EPG delivery systems. Since they are updated less often, these systems often mismatch the EPG to local listings, particularly when occurrence or schedule of a live broadcasted event is uncertain. The Broadcast Server 114 optionally performs additional localized functions with respect to the normalized data streams received from the Content Aggregators. However, modularization of these server components is optional.

The Broadcast Server 114 transmits the enhanced and normalized data streams to the client users for enhancing the viewing experience, as explained in further detail below. In one embodiment, the Broadcast Server 114 also performs the function of the Content Aggregator 402. In this embodiment, the Broadcast Server 114 receives from the Music Provider (or other provider) 414 heterogeneous data associated with different enhanced data from a variety of sources, television schedule information from a variety of sources (such as a cable provider, a satellite provider, a TV listings service such as the Tribune Media Service, or the like), and creates a single music or other themed schedule that relates the enhanced data with the different program listings to create “tunable” enhanced data. In an alternate embodiment, the different Content Aggregators 402 create enhanced theme schedules by issuing calls to a centralized TV listings database to extract the TV listing information and then map the extracted TV listings to the Event IDs as discussed above to create an enhanced schedule, which is then transmitted to the Broadcast Server 114 which transmits the schedules to the clients.

The Broadcast Server 114 also preferably manages and schedules the delivery of various formatted content streams. This may be performed by polling, in a real-time fashion, the availability of such content based on a set of delivery rules. Thus, for example, the delivery of data supplied by other content sources, such as advertisement information, may be appropriately scheduled.

The Broadcast Server 114 supplies the processed real-time data streams and mapped data enhancements through a transmission medium to the client system 100, such as via the network/cable transmission system shown in FIG. 1 or the satellite link to the client system. Other information such as EPG data may also be transmitted over these communications systems. The data streams are received by the receiver 120 and processed for presenting on display device 122. As explained below, the display device 122 is segregated into various display areas including a viewing area 122a for displaying a currently tuned television or digital audio channel, a dashboard or navigation display area 122b for presenting real-time music play-lists and other information and an information area 122c for providing real-time information concerning the music item currently selected.

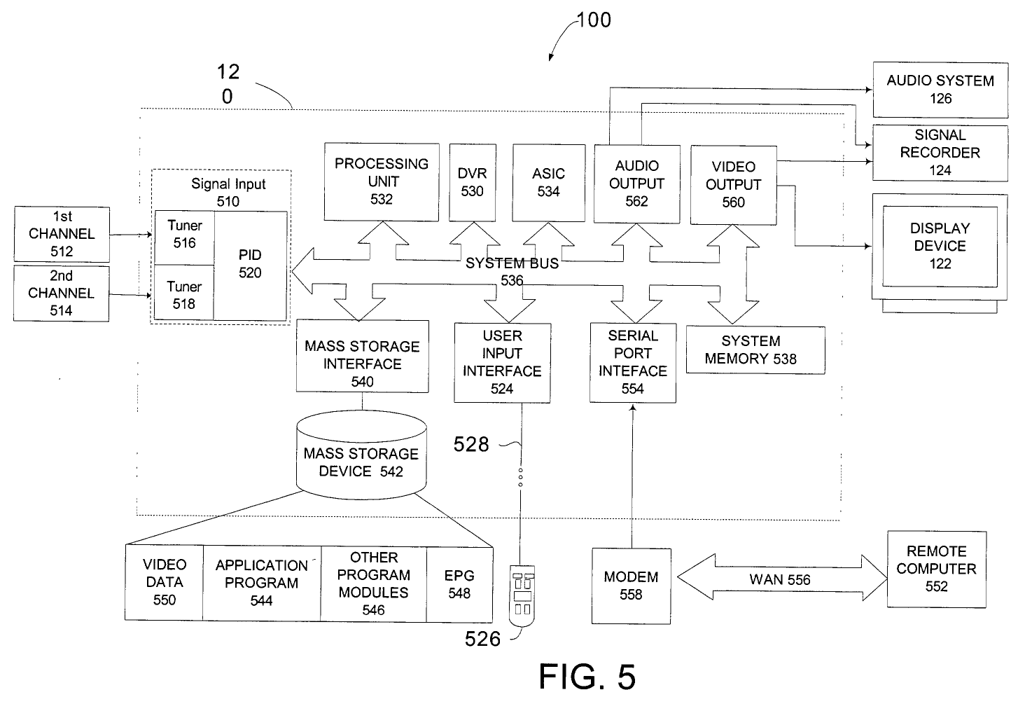

FIG. 5 is a block diagram representation of an exemplary client system 100. While the client system shown in FIG. 5 contains certain functionality, those skilled in the art will appreciate that the particular illustrated embodiment is intended represent certain functionality, which may be implemented in various ways. The client system 100 is implemented as a set-top box, video game console, or other embedded computing device that is configured to receive broadcast television programming and data services. The client system 100 includes two or more digital tuners for receiving digital satellite television programming and/or enhanced content. The client system 100 also includes advanced digital-video-recording (“DVR”) capabilities. This enables the simultaneous recording of television and audio channels as desired as well as pause, replay, slow motion and picture-in-picture viewing capabilities. The client system 100 facilitates audio and video navigation and viewing, as well as Internet navigation. However, those skilled in the art will appreciate that, while the above features are advantageous, many other client systems may be utilized to implement the invention as well, such as a cellular telephone, video game console, personal digital assistant (PDA), or other embedded computer device.

The client system 100 provides output video to a display device 122. The display device 122 may be implemented as a high definition television display, a standard television display, a computer monitor, or other device capable of displaying images or video represented by image or video data. The client system also includes an external signal recorder 124 and an audio system 126. The audio system represents a speaker, stereo system, or a device capable of presenting sound represented by sound data.

The client system 100 comprises a signal input module 510, which receives digital television programming and/or other data from first and second data communication channels 512 and 514 via first and second digital tuners 516, 518, respectively. While the programming is preferably transmitted via a digital satellite system (see FIG. 1), such information may also be transmitted via a digital cable system (see FIG. 4), cable or optic connection, a terrestrial antenna system, or any other device or system capable of transmitting programming and enhanced content to the home client system 100.

When the digital signal includes multiple channels, the first digital tuner denoted by the block 516 tunes to a selected frequency in the signal. Because digital transmission systems typically broadcast multiple content channels, the client system filters the desired content channel within the larger digital data stream at the particular frequency.

In the embodiments using multiple content channels provided over a single frequency, a trickle stream is sometimes replicated for the aggregated content streams on each individual frequency rather than for each content channel within the data stream on the individual frequencies. The client system tunes to the desired frequency, and simultaneously receives a content stream (from the plurality of content streams) as well as a trickle data stream on that frequency.

For filtering the content streams received by the tuners 516, 518, a Program ID (PID) filter, functionally shown as block 520, is used. Based on instructions corresponding to the desired program ID received from a central processing unit 532, the PID filter 520 filters the content stream(s) received from the tuners 516, 518 to provide content associated with the specified program ID('s) to the system bus 536.

Multiple digital tuners are preferably used to provide enhanced viewing features, such as picture-in-picture, recording one channel while viewing another, and recording a plurality of channels simultaneously. In the disclosed embodiment of the invention, at least one additional tuner 518 is adapted to receive the digital signal and tune to a second channel. This enables the enhanced content to be delivered over a separate channel where it is received by the tuner 518. However, even when the client includes multiple tuners, a trickle stream may be provided to avoid allocation of a tuner for receipt of enhanced content. This enables the user to utilize the additional tuner 518 for viewing and/or recording options, while at the same time receiving the services according to the invention.

The client system 100 also includes a user input interface 524, which receives input control signals from an input device 526 such as a remote control, a keyboard, a microphone, or other any other device capable of generating electronic instructions for the client system 100. Input device 526 is coupled to the client system over an input link 528 to enable transmission of such control signals. Input device 526 generates electronic instructions over input link 528 in response to preprogrammed data or in response to a user pressing buttons on input device 526. Input device 526 also controls web browser software within the client system 100.

FIG. 5 also illustrates a DVR device 530 for receiving video and/or audio data and recording such data on a storage medium. In the illustrated embodiment, the DVR device 530 is contained within the set-top box 120. Alternatively, or in addition to the internal DVR device 530, signal recorders such as recorder 124 may be provided external to the set-top box.

A central processing unit (CPU), illustrated as processing unit 532 in FIG. 5, controls operation of the set-top box 120. The CPU 532 is coupled to an application specific integrated circuit (ASIC) 534 and uses computer executable instructions implemented in software and/or hardwired logic circuitry. The CPU 532 and ASIC 534 are coupled via a system bus 536, which also interconnects various other system components. These include system memory 538, mass storage interface 540, user interface 524, and signal input device 510. The CPU 532 executes software designed to implement features of the client system 100 including features of the present invention. The ASIC 534 contains circuitry that is used to implement certain functions of the system. Instructions, data and other software necessary for the operation of processing unit 532 and the ASIC 534 may be stored in the system memory 538, and/or in a mass storage device 542, which is coupled to mass storage interface 540. The system memory 538 and mass storage device 542 are communicatively coupled to the ASIC 534 to permit data to be read from, or written to the system memory and possibly the mass storage device.

The mass storage device 542 is implemented as a magnetic hard disc or any other magnetic or optical mass memory device that is capable of storage large amounts of data. Computer readable instructions or data, including an application program 544, other program modules 546 and an electronic program guide (EPG) database 548, which specifies the broadcast times and channels of programs can be stored in the mass storage device. In addition to the EPG data provided by the second data communication channel, EPG data may be supplied on a regular basis to continually maintain a current schedule of programming at the client system 100. When the client system 100 is associated with the Internet, the data included in the EPG may be downloaded from the Internet. Alternatively, the EPG may be delivered to the client system by using a direct dial communication over standard telephone lines, or by using data transmission over the cable television infrastructure, a satellite network, an over-the-air broadcasting, or any other available medium, including a broadband IP network connection. Video data 550 is also stored on the mass storage device. As explained below, such data may thereafter be accessed and read out for viewing on the display device.

The client 100 typically communicates with a network server (not shown) and with other remote computers such as computer 552 as will be understood by those skilled in the art. Communication over a Wide Area Network 556 is facilitated by a serial port interface 554 that is interposed between the system bus 536 and a modem 558, or other appropriate means for establishing communications over a WAN 556, such as through a persistent, broadband IP network connection or by using any other available communication medium as described above. Although shown schematically in the embodiment of FIG. 5 as external to the set-top box, the modem 558 may be implemented as an internal device connected to the system bus 536. Also, the set-top box may include an external bus connection, such as a USB bus connection, for allowing connection of additional peripherals, including connection to a broadband network.

The client system 100 also includes a video output circuit 560 which may include a video encoder and/or a video converter. The video encoder assigns a code to frames of video data that are transmitted across a video image link and switches between analog and digital formats as necessary. Similarly, audio output circuit 562 can include an audio converter to provide the necessary switching between analog and digital formats.

The use of multiple digital tuners and one or more digital recording devices provides numerous advantages in implementing the present invention. For example, live television controls may further enhance the viewing experience. That is, such controls may be employed to pause for a particular time, e.g., 30 minutes, or to create instant replays, or to view action with slow motion control, even frame-by-frame, based on the live broadcast television signal. In a preferred embodiment, the client system automatically records enhancements so that the user may, at a later time, use interactive enhancements at his or her convenience.

The invention provides various user interface enhancements in the form of graphical and informational elements that overlay a portion of the display screen. As explained below, these enhancements aid the user in making informed decisions concerning available television programming.

One such user interface enhancement is a music audio and video navigation tool. The navigation tool provides improved interoperability with users as it guides the users to currently available music items across multiple networks. Thus, in one embodiment, the invention guides the user to music programs that are currently playing by presenting a play-list of such events in a navigation display area on the screen. The play-list presented in the navigation display area may also be filtered according to the user's preferences. That is, due to the number of music offerings at a given time, the play-list displays only the most recently played songs.

In accordance with one feature of the invention, the information presented in the navigation display area is based on filtered enhanced music data that presents up-to-date listing information to the user. For example, icons may be utilized to indicate the type of content concerning a particular event identified in the display area. In this embodiment, a user may select an appropriate video or audio program by selecting that portion of the navigation display area corresponding to the desired program. The system then automatically tunes to the channel corresponding to that program identified in the navigation display area. In addition, the display may present information such as events that will be available in the future.

To present such information to the user, the client system 100 shown in FIG. 5 is operable to extract the Event Identifier associated with the data provided in the generated content stream. The system then searches a previously delivered enhanced music schedule, which also contains associated Event Identifiers. This permits the system to automatically tune to the program corresponding to the Event Identifier based on a selection thereof by the user.

The Event Identifier data is associated with other generated content such as, for example, real-time indicators, Alerts, DVR index information, and other enhanced content. To provide this information to the client system for enhancing the viewing experience, the client system executes one or more application programs. These are based on one or more underlying data engines for processing the received content. Table 1 below identifies exemplary application programs that may be built on top of associated engines. As shown, an exemplary music application program creates navigation tools such as the “On now” tool. This program is built on top of a data processing engine adapted to process received real-time indicator data. Similarly, music alerts, such as when a performer starts playing on a specific channel, are provided with the use of an Alert processing engine. For providing video indexing or the like, a DVR engine performs the function of extracting indexing information. Also, an enhanced content processing engine enables the presentation of content such as music preview information used in conjunction with DVR features of the invention.

TABLE 1

| | | | | Television | |
|---|---|---|---|---|---|
| Engine | Music | Sports | News/Finance | Programs | Movies |
| Real-time | “On now” | “On now” | Story | “On now” | “On now” |
| indicators | radio, song | navigation | segments | navigation | navigation |
| | list | | | | |
| Alerts | Performer | Player | News alerts | Guest | Celebrity alerts |
| | starts playing | alerts, time | | Appearances | |
| | | in/time out | | on Talk | |
| | | alerts | | Shows | |
| DVR | Indexed | Game | Indexed news | Indexed | Indexed show of |
| | Music video | indexing | programs | Award | movie reviews |
| | | | | Shows. | or trailers |
| | | | | Record | |
| | | | | portions of | |
| | | | | shows | |
| | | | | (monologues) | |
| Enhanced | Discography, | Game | Related | | Filmography |
| content | related artists | previews | Content | | review w/record |
| | | with | w/record | | buttons |
| | | record | button | | |
| | | button | | | |

Other application programs may be implemented to use the same underlying processing engines.

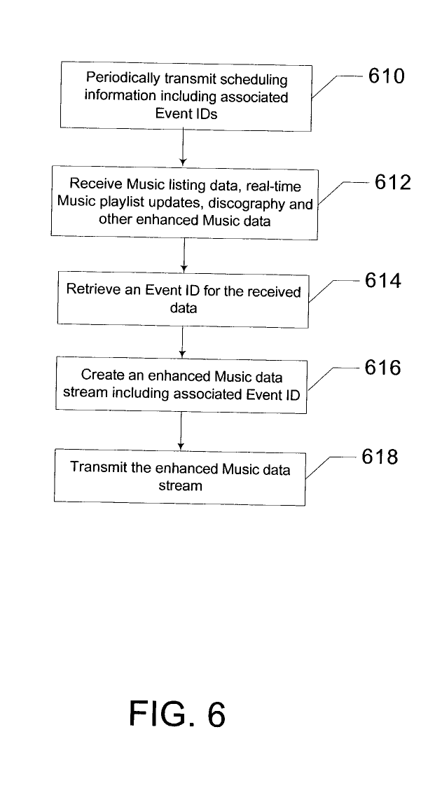

FIG. 6 is a flow chart illustrating certain operations of the Music Content Aggregator 402(4) shown in FIG. 4. For creating data streams with tunable Alert information that may be transmitted to one or more client systems, an enhanced music schedule is first created and transmitted to the Broadcast Server 114, and finally to one or more client systems, as shown at a block 610 in FIG. 6. Such scheduling information includes, for a particular music audio or video event, an associated Event Identifier. Then, during the occurrence of the event, the Music Content Aggregator 402(4) receives song listing data, other real-time music information and sometimes editorial data, and other music enhanced data, as shown at a block 612. As mentioned above, the Music Content Aggregator 402(4) also retrieves an Event Identifier for these data, as shown at block 614. Next, at block 616, the received content is associated with local channel information according to the Event Identifier. At block 618, the Aggregator 402(4) creates an enhanced music data stream, including the associated Event Identifier, for transmission. Finally, at a block 620, the enhanced data stream is then transmitted to the Broadcast Server 114 and finally to the one or more client systems. These steps may be performed by other service providers and/or server components as well.

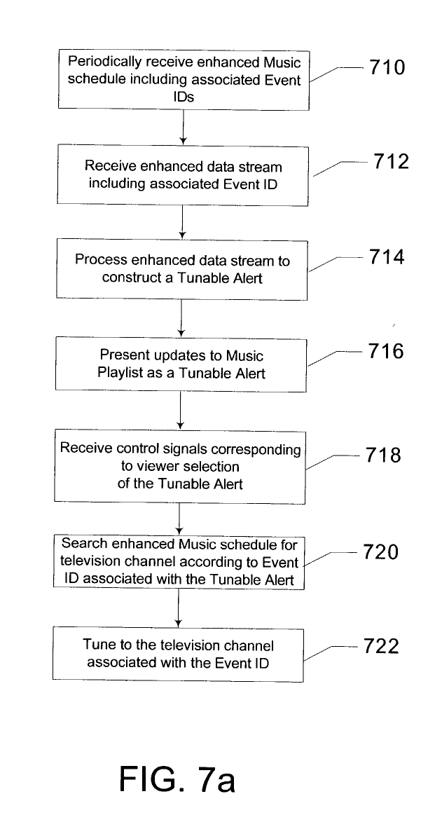

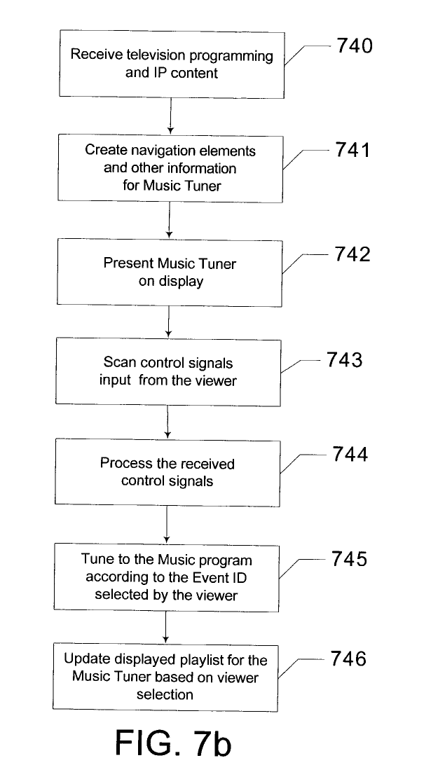

FIG. 7a and FIG. 7b illustrate flow charts in accordance with exemplary embodiments of the client system 100 for enabling creation of a real-time music play-list based on the receipt of tunable Alerts. In FIG. 7a, the client system periodically receives an enhanced music schedule with associated Event Identification data, as shown at block 710. The client also receives an enhanced data stream, which also includes Event Identification data, at block 712.

Since the music content providers typically do not preannounce a music play-list and since the client system cannot simultaneously tune to all of the broadcast music offerings, the system creates a real-time play-list based on the enhanced data stream. Thus, at block 714, the client system constructs a tunable Alert based on a currently playing song, as identified in the received data stream. The Alert provides information concerning a song that is about to be played or that is actually playing on a particular channel. Similarly, tunable Alerts for currently playing songs on other music channels are also created. At block 716, the tunable Alert, in this case an identification of a currently playing song, is presented on the display device.

Upon receiving a control signal corresponding to the user's selection of the tunable Alert at a block 718, the client system searches the list of tunable alerts constructed from the enhanced data stream for the television channel according to the Event Identifier associated with the tunable Alert, as shown at a block 720. Finally, at a block 722, the client system tunes to the television channel associated with the Event Identifier.

FIG. 7b shows an operational flow chart of an application program, executing on the client system 100, to create a Music Tuner interface according to the invention. The Music Tuner is an updated music play-list based on received content that is associated with corresponding audio and video programming. Execution of the program begins at block 740. In this step, broadcast programming data and enhanced content are initially received by the client system. As noted above, the programming data and the enhanced data are associated with their own unique identification information. Next, at block 741, the system operates to create navigation elements and other enhanced content based on the received content. As explained below, this step includes creating a play-list and other notifications, based on tunable Alerts or other real-time indicators, which inform the user of the active status of music audio and video programs. In addition, the system maps the program and content identification data to permit the enhanced content to be wrapped around the video and audio programming as presented to the user. Thus, at block 742, the client system 100 presents a music play-list having one or more navigation elements on the display. In many instances, the system also presents a viewing window for displaying a currently viewed program.

At block 743, the system then receives control signals or other input information received from the user. These signals correspond to user selection of a desired song or music program by highlighting or otherwise selecting a navigation element on the display. They are usually entered via the remote input unit 526 shown in FIG. 5. The system then processes the input control signals at step block. Next, at block 745, the system operates to tune the broadcast program selected by the user. Finally, at block 746, the system updates the presented navigation elements and the viewing window. In the case of digital audio programs, the currently selected item is then moved to the beginning of the play-list.

While the Alerts described in conjunction with FIG. 6, FIG. 7a and FIG. 7b have been “tunable,” Alerts that enable the client system to tune to an appropriate channel based on a previously associated Event Identifier, the invention may also be used to provide other types of Alerts. Such Alerts typically invoke another particular action by the client system. For example, an Alert sometimes triggers actions such as an extendable video recording. This may occur when music awards programs last longer than expected. Another example of such an alternative type of Alert is a speculative record Alert. This Alert causes a client system to record an event that is of particular interest, even though the user did not request the system to record the event. For example, one type of speculative recording alert selected by the user causes the DVR engine to record all music videos of a particular genre. Thus, in this embodiment, an alert is transmitted to notify the client engine that a particular music video is being broadcast. The alert corresponds to an Event ID, and the DVR then tunes to the channel specified by the Event ID to record the program. Another example of this feature is to speculatively record all award shows that are in the last half-hour (on the assumption that the most important awards are presented then), or all late night talk shows in a certain timeframe, such as in the last 10 minutes, to record the music segments.

Although “tunable” alerts have been described, the present invention also enables the broadcast of alerts that may simply inform a user that an event of interest is about to occur. For example, if a music program is about to discuss a user's favorite artist, an alert may be sent to an interested user's cell phone. The cell phone alert will simply inform the user that currently a program is being broadcast that is about to discuss the artist of interest. The user can then either find a nearby television or other tunable device (such as a computer with a tuner card) to watch the program or can request that the program be recorded on the customer's home recording machine. In this embodiment, the cell phone, PDA, or other non-tuner device is also downloaded the enhanced theme schedule that relates enhanced data to television program listings (as customized for the user). When the user selects the alert, the alert in this example merely displays the programming information or provides an option to remotely record the show.

The Alerts according to one embodiment of the invention may also be personalized according to a user's interests or tastes. By way of example, such personalized Alerts may occupy a particular area of real estate on the User Interface and be displayed on a Music Tuner interface, as explained below. Since they are typically indexed to real-time data, they may extend across other programming as well. Thus, for example, an Alert may appear when a particular musical artist is about to appear on a television program. This may optionally occur when an artist of particular interest to the user appears on a television program, either on a channel displayed on the Music Tuner interface or on any other television or digital audio channel. In this case, a personalized Alert informs the user that the artist is about to appear. Such Alerts may also be provided in advance of the actual appearance or program.

In addition to informing the user of certain information concerning programming, alerts may be used to associate commerce opportunities with the artist that is being played. Thus, for example, an alert may be used to associate the programming with items that may be purchased such as a CD of the artist, tickets for an upcoming concert, to purchase other items such as clothing of the artist. This may be performed in real-time while the artist is being played by the system. This feature brings significant value to merchants who can advertise specific products that are directly associated with a viewer listening or watching the related artist.

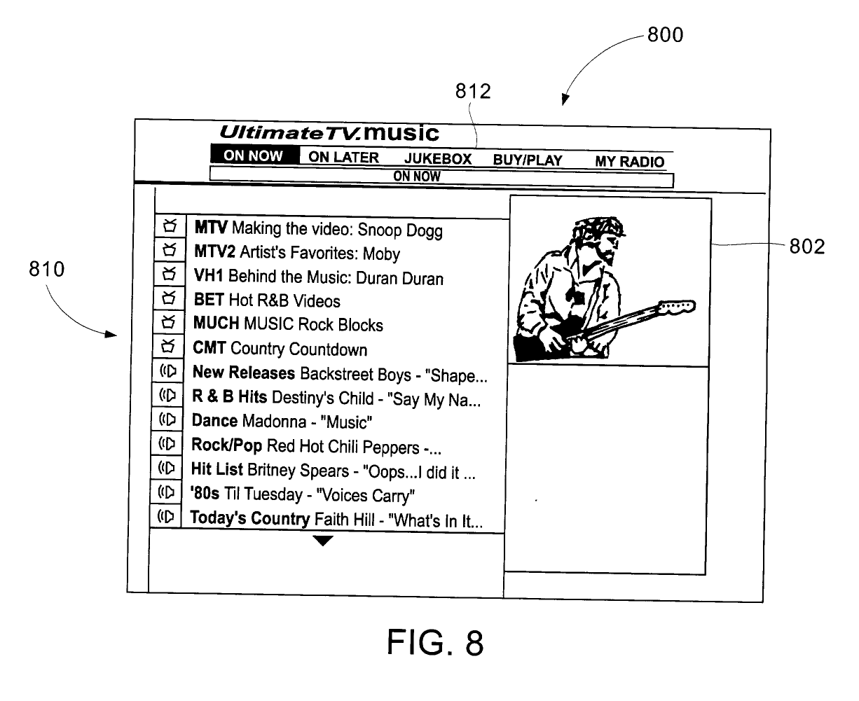

FIGS. 8 through 14 illustrate a user interface or display rendered by an application program using the data services delivered according to the invention. In these embodiments, the user interface has several unique display areas: a program viewing display area, a navigation guide area, and an information display area. The program viewing display area is generally used to view television programming such as a particular music video or a still frame associated with a song provided via a digital audio channel. While in a navigation operational mode, this display area is reduced to a window size that only uses a portion of the display screen. The program viewing area may be resized based on an input request by the user. It should be understood, however, that the invention is not limited in any way to the specific manner in which the various window elements, such as the music play-list and the video display area, are placed on the screen in the described embodiments.

FIG. 8 shows the general layout of a novel music navigation guide 800. The navigation guide includes a viewing window 802. In addition to the viewing window, the screen display contains a navigation guide 810, in this instance a Music play-list or Music Tuner, and a coarse navigation bar 812. The coarse navigation bar 812 provides a filter for the general types of information presented in navigation guide area 810. In this way, the user may optionally select audio and video content that is either “On Now” or “On Later.” Also, the user may select content that is maintained on a storage device through a “Jukebox” button, access a “Buy/Play” button, and a “My Radio” button.

The elements presented in the navigation guide area 810 present a Music tuner interface to the user. In one embodiment, these elements are logically grouped by either video or audio programs. That is, currently available music television channels are provided at the top of the Music Tuner play-list. These available channels also include a television icon to inform the user that the channel is a television channel instead of a digital radio channel. In one embodiment, the music television channels are ordered in a static play-list. Next, the currently available digital audio items are grouped according to channel. As with the television channels, an audio icon is provided as a cue with each channel provided in the play-list. However, since there are numerous digital audio channels available to the user, the system only displays the most recently accessed digital audio channels, as explained below.

FIG. 9 also shows the navigation guide after a selection of the “On Now” button in the coarse navigation bar in order to filter the currently available music items in the navigation guide area 910. As with the embodiment shown in FIG. 8, the navigation guide area 910 comprises navigation elements that are further segregated by music video and audio channels. In this exemplary navigation guide, the user has selected a currently broadcast music video in the Music Tuner portion 910. As a result, the system tunes to the television channel associated with the Event ID provided with the selected navigation element 914. The program display window 902 presents the currently selected music video. To view the music video in a full screen mode, the user may select the viewing window 902 or take some other action.

As described, each of the navigation elements in the guide area 910 has certain information to assist the user in the decision-making process. For example, the first navigation element shown in FIG. 9 corresponds to the broadcast of a currently available music video on a particular channel, MTV. Real-time indications concerning the currently playing television program are also presented. Other visual cues, such as a television icon in this navigation element, provide the user with information concerning the type of programming.

In a second type of navigation element shown in FIG. 9, namely, a digital audio channel, visual cues are provided in the form of a speaker icon to indicate that the music channel corresponds to an audio channel only. This advantageously provides one important cue to the user, namely, the type of broadcast programming.

In accordance with another aspect of the invention, the entries in the Music Tuner are cached as a temporary list on the client system. Then, when a song change occurs, the client system receives a tunable Alert indicating the change. Such information is presented in conjunction with enhanced music data in the navigation guide area. This provides up-to-date information as to an item that is about to be broadcast in one or more of the currently available programs. Since the Alerts and listing information include associated Event Identification data, they enable the client system to automatically tune to the associated channel upon selection by the user.

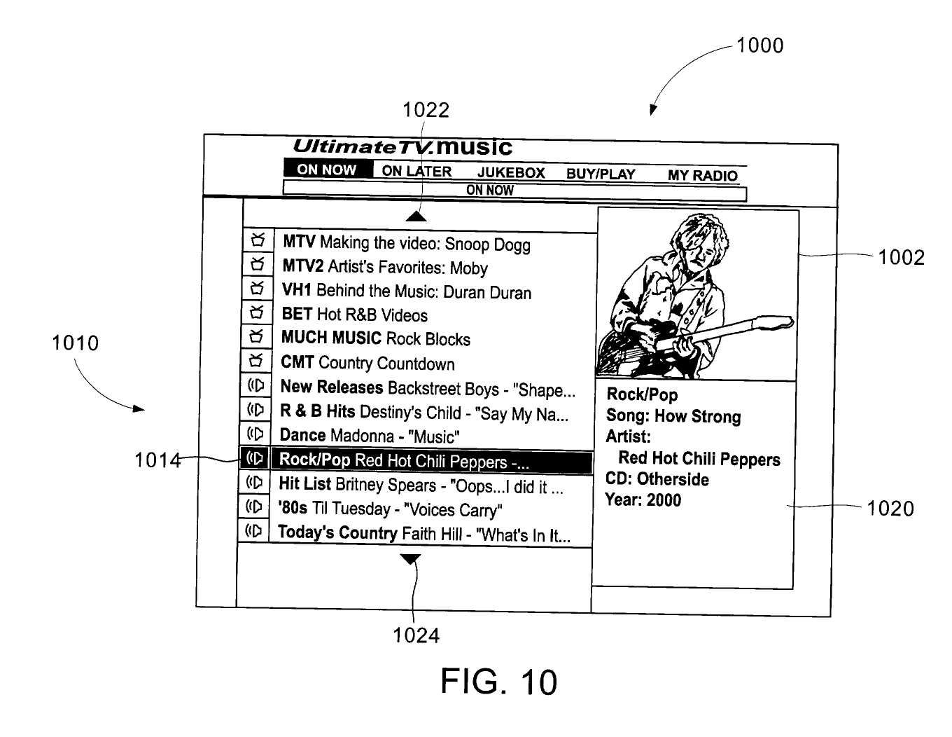

FIG. 10 illustrates a navigation screen 1000 similar to the screen presented in FIG. 9. In this navigation screen, the user has selected a digital audio channel. In one embodiment, a display area 1002 presents a still frame corresponding to the audio selection, such as a depiction of the CD cover artwork for the currently playing song. In many instances, certain data cannot be displayed in the Music Tuner display area 1010 due to real estate considerations. Thus, additional data corresponding to the user selection 1014 is presented in an information window 1020. In this instance, such additional information includes the full name of the selected song title, the full name of the artist, the album and year of introduction of the album. Of course, other information may be presented in this window.

In addition to viewing windows, the display 1000 includes user selectable arrows or controls. In the display screen shown in FIG. 10, the Music Tuner 1010 includes scroll-up and scroll-down arrows 1022 and 1024 to enable the user to browse more music selections. Thus, the user may readily tune to other digital audio or video channels when desired.

In order to navigate through the various display screens or to select a desired program, the user preferably uses the input control pad 526 shown in FIG. 5. When the user has selected a display area or a display element in the Music Tuner that corresponds to available audio or video programming, that display element will be highlighted. Alternatively, the color of the display area may change to indicate that the user has selected the display area. As explained above, the data presented by the client system includes a previously associated Event ID. When the user selects a desired display area, the system looks up the appropriate channel in the previously delivered enhanced music schedule and automatically tunes the television to that channel, which displays the selected programming.

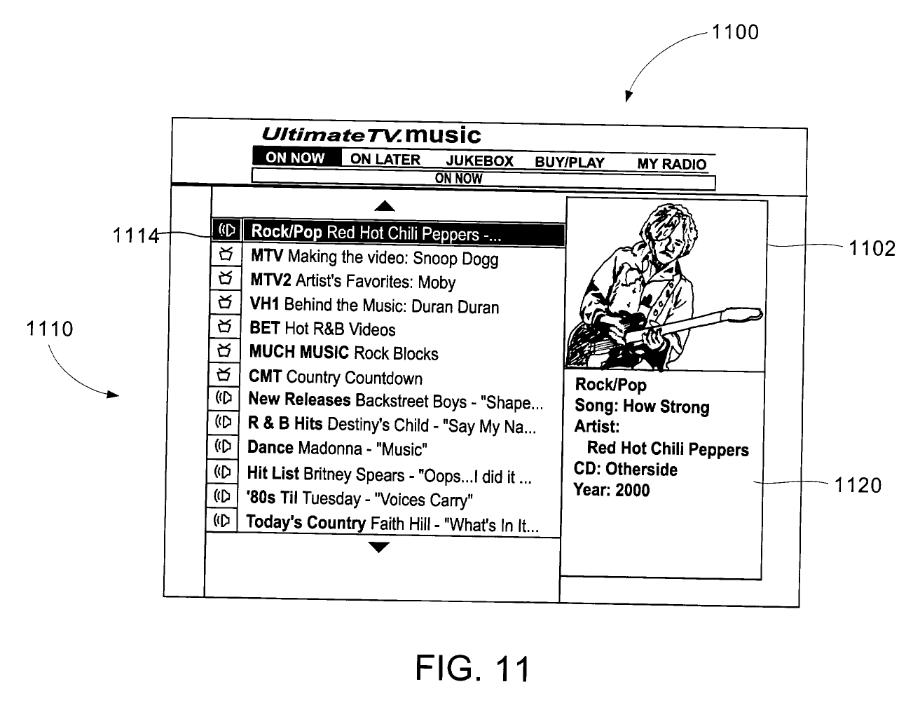

FIG. 11 illustrates a reordering of the play-list as a result of user selection of an audio channel in the navigation area 1110. The presented screen 1100 is segregated into a first display window area 1102 that presents a still frame corresponding to the selected channel, a navigation or Music Tuner area 1110, and an information area 1120. The navigation area 1110 displays a list of both music television channels and digital audio channels. In one embodiment as shown, graphical icons are used to allow the user to easily distinguish between video and audio programming. While the navigation area is shown as a play-list having certain truncated music listings, those skilled in the art will appreciate that the play-list may optionally include the complete song titles and artist with fewer items on the play-list. Also, the display area may be divided into a number of different spatial areas and listing presentations.

For providing an enhanced experience, the order for the navigation elements is updated when the listener selects a video and audio channel and displays its full-screen representation. When the listener returns to the list, the selected channel is moved to the beginning of the list. Thus, in the embodiment shown in FIG. 11, the currently selected audio channel 1114 is moved to the beginning of the play-list when the listener displays a full-screen representation of the selection and then returns to the play-list. Similarly, when the listener leaves the music service and returns later, the play-list will reflect the new priority order. Alternatively, the play-list may be updated in accordance with other defined rules, or even in real-time as the viewer makes a selection. Also, the information area 1120 may be configured to present tunable Alerts such as the personalized Alerts explained above. In this instance, a personalized Alert appears upon the occurrence of a musical event that may be of interest to the user. For example, such an Alert may be presented when an artist of particular interest to the user appears, is about to appear, or will sometime in the future appear, on another channel. As explained above, personalized Alerts may be created as a function of user preferences provided to the service.

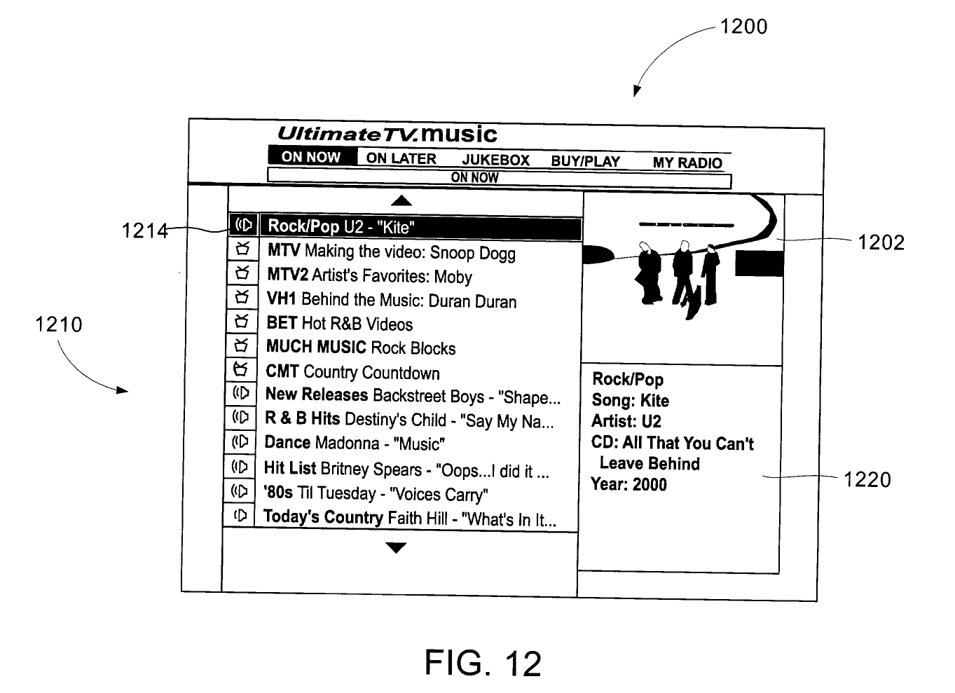

FIG. 12 illustrates a screen display 1200 that is similar to the display screen 1100 shown in FIG. 11, in that it includes a viewing display area 1202 and a Music Tuner or navigation area 1210. In this instance, however, the currently playing song on the tuned channel has changed. According to the invention, the client system receives an Alert indicating the song change. As a result, the navigation display area 1210 is updated to present information concerning the new song. That is, one or more navigation elements such as element 1214 are changed to reflect the new song. In addition, if the alert is for the channel that is currently selected, the viewing area 1202 is updated with a still frame or other graphics or information concerning the new song. As explained above, such information may be provided to the client system during low-peak times and stored on the client system. The information contained in the information display area 1220 is also updated to reflect content concerning the new song.

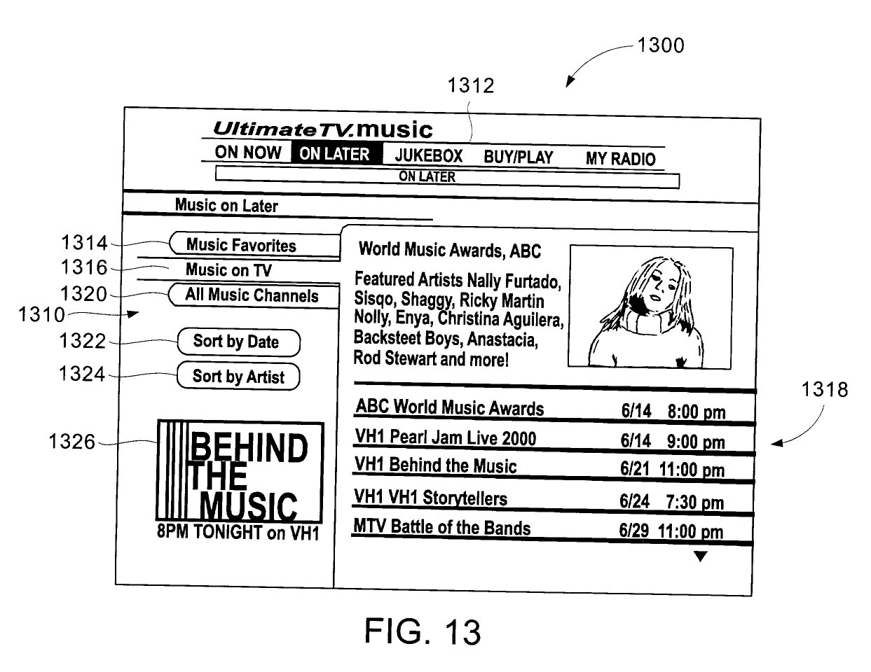

FIG. 13 illustrates a further navigation display screen 1300 that provides information concerning music audio and video programs that will be broadcast at some later time. In the illustrated embodiment, the user has selected an “On Later” button in the coarse navigation bar 1312. The display screen also includes a navigation guide area 1310. To provide such content, the application performs a search of EPG listings and other data services, such as those provided in the content streams produced by the Music Content Aggregator 402(4).

Various navigation elements in this area of the display provide various filters for presenting future music content choices. The filters are selected with the use of various buttons, such as a “Music Favorites” button 1314 that provides future listings for programs that have been previously identified by the user. A “Music on TV” button 1316 may be selected to filter the future program listing to future music television programs. In the illustrated embodiment, when the button 1316 is selected, a listing is presented as a scrollable menu 1318 that is displayed opposite the navigation guide area 1310. In addition to a listing of future television programs, the listing may also include promotional content to attract the user to a particular program. Also, an “All Music Channels” button 1320 may be selected to obtain access to a listing of all available music content.

Other filters are used to present the future content in a user manageable format as well. These include a “Sort by Date” button 1322 and a “Sort by Artist” button 1324. In addition, the future content may be sorted by genre view. Finally, an advertisement window 1326 is used to provide additional information concerning future programs.

Digital video recording features are also integrated in a DVR engine executed by the client system according to the invention. That is, the client system processes received real-time and other data services to provide enhanced DVR features. As explained above, the Broadcast Service generates triggers corresponding to indices to permit storage, playback and viewing of recorded music audio and video segments. These include real-time event notifications concerning items of interest that correspond to specific points in the recorded video stream.

The invention also enables the creation and use of DVR navigation tools. For example, the invention may be used to create a personalized Jukebox as shown by the coarse navigation bar. In this instance, the invention permits a user to “intelligently record” only those portions of a particular program or video. Alternatively, the user may opt to simply skip from one recorded music video to the next video.

The invention creates a plurality of indices by associating received event logs with the appropriate locations of the recorded video on the storage medium. As explained above in the case of an indexed music video broadcast, the Music Content Aggregator 402(4) captures and packages event logs concerning a television program as a plurality of DVR index files. The index files are transmitted to the client system that associates the index file or files with a corresponding recording, if one has been obtained by the client system.

While the invention has been described primarily in conjunction with the integration of disparate data sources such as real-time enhanced data, Event Identification data and broadcast television programming, those skilled in the art will appreciate that many other data sources and data types may be integrated as well. For example, in the alternative or in addition to enhanced scheduling data, the invention may be used to integrate real time enhanced data with Event Identification data so that the user may make an informed decision on the programming of choice.

Various advantages and features flow from the present invention. In prior systems, EPG data and other information were only statically presented to the user. Such information was decoupled from the broadcast programming. In contrast, the present invention permits real-time information to be provided with the programming.

Accordingly, an enhanced television service meeting the above objectives has been described. It should be understood, however, that the foregoing description has been limited to the presently contemplated best mode for practicing the invention. It will be apparent that various modifications may be made to the invention, and that some or all of the advantages of the invention may be obtained. Also, the invention is not intended to require each of the above-described features and aspects or combinations thereof. In many instances, certain features and aspects are not essential for practicing other features and aspects. The invention should only be limited by the appended claims and equivalents thereof, since the claims are intended to cover other variations and modifications even though not within their literal scope.

What is claimed is:

1. A method for presenting a dynamic navigation interface comprising the steps of:
receiving a plurality of broadcast television programs relating to a specific theme, each of the plurality of television programs including an Event ID;
receiving enhanced Internet protocol (IP) data including an Event ID associating the IP data with at least one of the plurality of programs;
presenting, on a video display, a listing including a series of visual cues based on the IP data, each of the visual cues corresponding to a currently playing television program relating to the specific theme;
receiving a user selection of one of the visual cues;
tuning to a channel associated with the event ID in response to user selection of the visual cue; and
reordering the series of visual cues in the listing after the user selection of one of the visual cues.

2. The invention as in claim 1 wherein the theme is music.

3. The invention as in claim 2 further including the steps of
receiving a plurality of broadcast digital audio channels, each of the broadcast digital audio channels including an Event ID;
receiving enhanced Internet protocol (IP) data including an Event ID associating the IP data with at least one of the plurality of digital audio channels; and
presenting a second series of visual cues based on the IP data on the video display.

4. The invention as in claim 3 further including the steps of
receiving a user selection of one of the second visual cues; and
tuning to the audio channel associated with the event ID in response to user selection of the visual cue.

5. The invention as in claim 4 wherein the video display is a conventional television receiver.

6. The invention as in claim 4 wherein each of the series of television visual cues corresponding to a currently playing television program comprises a program listing and an icon, the icon indicating that the program listing is a television program.

7. The invention as in claim 6 wherein each of the series of audio visual cues comprises an audio listing and an icon, the icon indicating that the program listing is a digital audio program

8. The invention as in claim 1 wherein the Internet protocol data portion is filtered to correspond to currently available music television programming.

9. A Music Tuner comprising:
A method for presenting a dynamic navigation interface comprising the steps of:
receiving a plurality of broadcast television programs relating to a specific theme, each of the plurality of television programs including an Event ID;
receiving enhanced Internet protocol (IP) data including an Event ID associating the IP data with at least one of the plurality of programs;
presenting, on a video display, a listing including a series of visual cues based on the IP data, each of the visual cues corresponding to a currently playing television program relating to the specific theme;
receiving a user selection of one of the visual cues;
tuning to a channel associated with the event ID in response to user selection of the visual cue; and
reordering the series of visual cues in the listing after the user selection of one of the visual cues.

10. A method for presenting a tunable Alert on a television receiver concerning a broadcast music program comprising the steps of:
receiving television scheduling data concerning a plurality of televised music events, each of which includes an associated unique event identifier;
receiving a content stream including at least one unique event identifier while one of the plurality of music events is being broadcast;
presenting a tunable alert in response to the received content stream;
in response to user selection of the tunable alert, determining a channel associated with the alert based on the unique event identifier; and
automatically tuning to the associated channel.

11. The invention as in claim 10 wherein the content stream is a real-time content stream.

12. The invention as in claim 11 wherein the tunable alert presents information concerning other in-progress music events.

13. A method for presenting a visual indicator on a television device concerning a currently available music offering comprising the steps of:
receiving an active status indicator only while a music event is active and at least one unique event identifier associating the active status indicator with the televised music event;
processing the status indicator;
presenting an active status alert in response to the received content stream;
in response to user selection of the active status alert, determining a channel associated with the alert based on the unique event identifier; and
automatically tuning to the associated channel.

14. A method for delivering enhanced television programming data comprising the steps of:
receiving a schedule for a plurality of television listings, each of the plurality of television listings including a unique event identifier;
receiving enhanced Internet protocol (IP) data including an event identifier associating the IP data with one of the plurality of television listings;
presenting a visual cue based on the IP data on a display device informing a user of an action.

15. A method of providing enhanced television services comprising:
receiving a music data string, wherein the music data string is associated with tuning information;
displaying a representation of the music data string on a display device;
receiving a selection from the user of the representation of the music data string; and
tuning a display device to display a channel responsive to the tuning information associated with the music data string.

16. The method as in claim 15 further including the steps of:
receiving an updated music data string associated with tuning information; and
displaying an updated representation of the music data string on the display device.

17. The method as in claim 16 wherein the music data string includes information relating to the presentation of a music video on a television channel.

18. The method as in claim 17 wherein the music data string includes information relating to a currently televised music video on a television channel.

19. The method as in claim 18 wherein the music data string includes information relating to the presentation of an audio program on a digital audio channel.

20. The method as in claim 19 wherein the music data string includes information relating to a currently broadcast song on a digital audio channel.

21. A method for creating digital video recording enhancements for music programming comprising the steps of:
creating program event log indices marking events in the program meeting program-specific rules; and
transmitting the program event log indices to a client system.

22. The invention of claim 21 wherein the program event log indices are created as the program is broadcast.

23. The invention of claim 22 wherein the program event log indices are transmitted to the client system in real-time.

24. The invention of claim 21 wherein the program-specific rules relate to music programming.

25. A method for processing video recording enhancements in a client system adapted to receive television and audio programming comprising the steps of:
receiving the television programming;
storing the television programming as a recorded program;
receiving program event indices developed according to one or more defined rules applied to the television programming; and
associating the program event indices with corresponding segments in the recorded program.

26. The invention of claim 25, wherein at least one of the plurality of defined rules requires an event log to be captured upon the occurrence of a certain action in the television programming.
